(19) United States
(12) Patent Application Publication
(10) Pub. No.: US 2025/0139712 A1
(43) Pub. Date: May 1, 2025

(54) Metal Application

(71) Applicant: Nnenna Onyinye Uboma, Milton (CA)

(72) Inventor: Nnenna Onyinye Uboma, Milton (CA)

(21) Appl. No.: 18/885,656

(22) Filed: Sep. 15, 2024

Related U.S. Application Data
(60) Provisional application No. 63/583,325, filed on Sep. 18, 2023.

(51) Int. Cl. G06Q 50/00; G06Q 20/38

(52) U.S. Cl. CPC G06Q 50/01; G06Q 20/383

(57) ABSTRACT

A mobile application for fostering meaningful connections through advanced matching algorithms, prioritizing personality traits and shared values over physical attributes. The app ensures user privacy with anonymity features, allowing controlled identity disclosure. It incorporates virtual gifting and loyalty rewards to enhance engagement. The platform supports various relationship types, including dating, mentorship, and professional networking, with flexibility for virtual or in-person interactions. Key features include a sophisticated matching algorithm, robust privacy controls, and a hybrid connection model blending digital and physical experiences. The app also offers anonymous dispute resolution and secure, anonymous commerce capabilities, providing a comprehensive solution for building authentic relationships in the digital age.

### REFERENCE TO RELATED APPLICATIONS

The present application claims domestic benefit of provisional patent, U.S. patent Application No. 63/583,325 filed on Sep. 18, 2023, 2009, titled “Metal Application”

### BACKGROUND OF THE INVENTION

Traditional dating, mentorship, and networking platforms often prioritize superficial attributes, leading to shallow connections and missed opportunities for meaningful relationships. These platforms typically lack robust privacy features, forcing users to reveal personal information prematurely. Additionally, existing apps often fail to provide a comprehensive solution that caters to various types of relationships, from romantic partnerships to professional mentorships.

Current platforms also struggle to bridge the gap between online interactions and real-world meetings, limiting the depth and authenticity of connections formed. Furthermore, many apps lack engaging features that encourage sustained user interaction and loyalty.

There is a need for an innovative application that addresses these shortcomings by prioritizing compatibility based on personality traits and shared values, ensuring user privacy, and offering a versatile platform for various types of relationships. Such an app should also provide a seamless transition between virtual and in-person interactions, while incorporating features that enhance user engagement and foster deeper connections.

### BRIEF STATEMENT OF THE INVENTION

The present invention provides an innovative mobile application designed to revolutionize the way people form and maintain relationships across various contexts, including dating, mentorship, and professional networking. This invention addresses the shortcomings of existing platforms by prioritizing meaningful connections based on personality traits and shared values rather than superficial attributes.

The core of the invention is a sophisticated matching algorithm that considers users' relationship goals, personal preferences, and desired connection types to generate curated lists of potential matches. This approach ensures more authentic and compatible connections from the outset.

Privacy and anonymity are at the heart of this app. Users can stay completely in control of their identities, choosing to remain anonymous until they're ready to share more about themselves. This feature not only keeps users safe but also allows connections to grow naturally, without the usual pressure or superficiality found on other dating or mentorship platforms.

The invention incorporates several novel elements to enhance user engagement and experience:
1. A virtual gifting system that allows users to express interest and appreciation. creatively.
2. A loyalty program (Spark Loyalties) that rewards active participation.
3. Flexible meeting options, including both virtual and in-person interactions.
4. Ice-breaking games designed to facilitate self-discovery and deeper connections.

Additionally, the invention includes an anonymous dispute resolution mechanism and a secure marketplace for anonymous commerce, further enhancing user safety and engagement.

By addressing the problems identified in existing platforms, this invention aims to create a more holistic, secure, and engaging environment for building meaningful relationships. It offers a versatile solution that caters to various relationship needs while prioritizing user privacy, engagement, and authentic connections.

### SUMMARY OF THE INVENTION

The present invention relates to a mobile application designed to facilitate meaningful connections for dating, mentorship, and professional networking. The primary object of this invention is to address the shortcomings of existing social networking platforms by providing a more secure, engaging, and versatile solution for building relationships.

This invention employs a sophisticated matching algorithm that prioritizes personality traits and shared values over physical attributes, solving the problem of superficial connections prevalent in current applications. The algorithm processes detailed user input to generate curated lists of potential matches, ensuring more compatible and authentic connections.

To address privacy concerns, the invention incorporates a robust anonymity system. Users can interact without disclosing personal information until they choose to “unmetal,” allowing relationships to develop organically without premature identity revelation.

The invention enhances user engagement through several novel features:
A virtual gifting system
A loyalty program (Spark Loyalties)
Flexible meeting options (virtual and in-person)
Ice-breaking games for self-discovery

Additionally, the invention includes an anonymous dispute resolution mechanism and a secure marketplace for anonymous commerce, addressing the lack of conflict resolution tools and limited transaction options in existing platforms.

By offering a comprehensive solution for various types of relationships and bridging the gap between online and offline interactions, this invention solves the problem of limited scope found in current applications. The combination of these features creates a more holistic, secure, and engaging environment for building meaningful relationships, thereby advancing the state of the art in social networking and relationship-building applications.

### BRIEF DESCRIPTION OF DRAWINGS

FIG. 1: Overall architecture of the Metal App system

FIG. 2: Metal App Sign-up/Sign-in Flow diagram

FIG. 3: Anonymous Matching and Conversation

FIG. 4: Anonymous Marketplace Process

FIG. 5: Metal App dispute resolution flow

FIG. 6: Factors contributing to Meaningful Connection

FIG. 7: Enhanced user Experience through virtual gifting and loyalty rewards

FIG. 8: Core App Features

FIG. 9: User Dashboard to view thoughts

FIG. 10: Ability to post your thoughts

FIG. 11: Send Melt Request

FIG. 12: Anonymous user profile

FIG. 13: View Thoughts of a user

FIG. 14: Earn Referral points

FIG. 15: Buy, Send or Earn Sparks

FIG. 16: Various relationship interests

FIG. 17: Process to reveal your identities

FIG. 18: Options for first meeting

FIG. 19: Booking process for first date

FIG. 20: Booking confirmation process

FIG. 21: Message history with list of matches where some are Metals and some Unmetals

FIG. 22: Message display when chatting with a match that has unveiled their face

### DETAILED DESCRIPTION OF THE INVENTION

The present invention, referred to as the Metal App, is a comprehensive mobile application designed to revolutionize the way people form and maintain relationships across various contexts, including dating, mentorship, and professional networking.

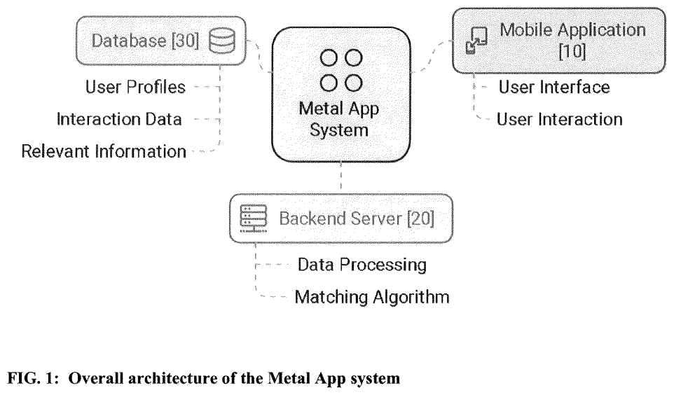

FIG. 1 illustrates the overall architecture of the Metal App system. The system comprises a mobile application [10], a backend server [20], and a database [30]. The mobile application [10] serves as the user interface, while the backend server [20] handles data processing and the sophisticated matching algorithm. The database [30] stores user profiles, interaction data, and other relevant information.

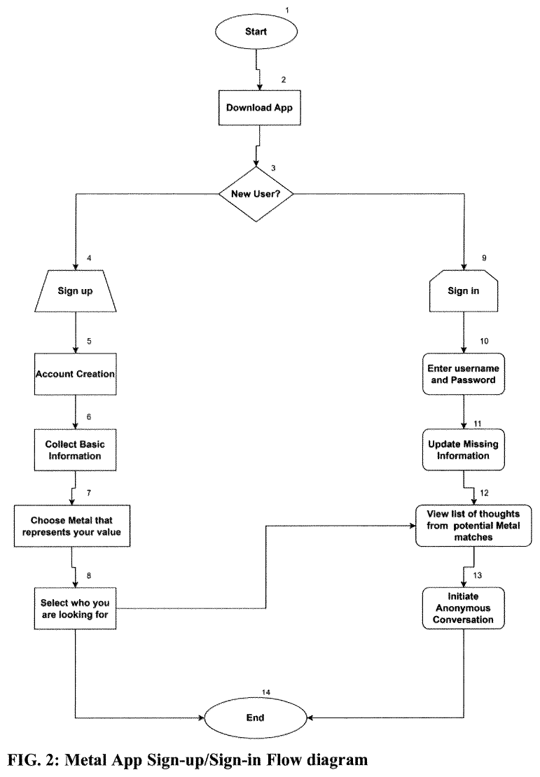

FIG. 2 illustrates the flow of the user interaction process. The process begins by downloading the app [1]. New users [2] proceed by signing up [3], creating an account [4], and providing basic information [5]. Users then choose a metal that represents their value [6] and specify who they are looking for [7].

Returning users [8] sign in using their username and password [9]. If any information is missing, they update their profile [10]. The system then presents a list of thoughts from potential matches [11], after which users may initiate anonymous conversations [12].

Both new and returning users complete the process and reach the end [13].

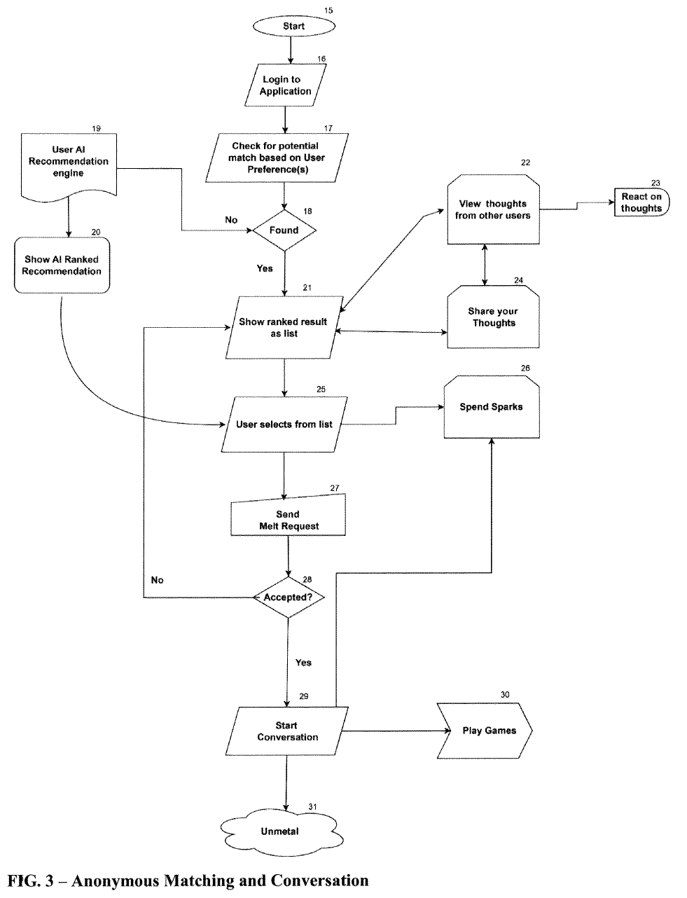

FIG. 3 outlines the flow of the anonymous matching algorithm. The process starts with a user logging into the application [16]. The system checks for potential matches based on the user's preferences [17]. If no match is found [18], the user is shown AI-ranked recommendations [19]. If a match is found [20], the system displays ranked results as a list [21].

The user can then view thoughts from other users [22], react to those thoughts [23], or share their own thoughts [24]. Once the user selects from the list [25], they can send a Melt request [27]. Additionally, users may spend sparks [26] to enhance their interaction.

If the Melt request is accepted [28], the user starts a conversation [29] and can play games [30] and can end with unmetal [31], which is a process of revealing your true self to another party. If not, the process redirects to another attempt [21].

The matching algorithm prioritizes personality traits and shared values over physical attributes, addressing the problem of superficial connections in existing platforms. By considering a wide range of factors, including interests, life goals, and communication styles, the algorithm ensures more compatible and authentic connections.

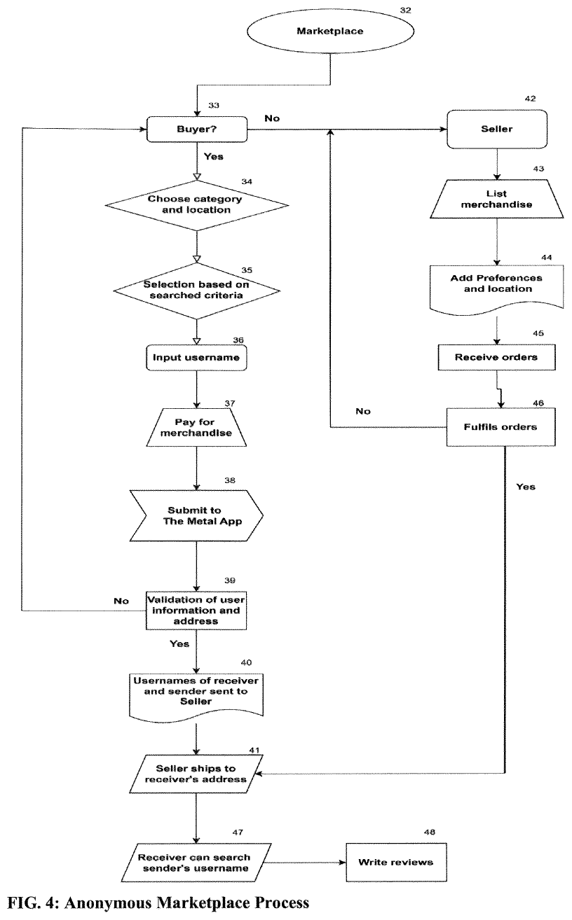

FIG. 4 illustrates the flow of the marketplace system. The process begins by determining whether the user is a buyer or a seller [33]. If the user is a buyer [34], they select a category and location [35], then view selections based on their search criteria [36]. The buyer inputs their username [37] and proceeds to pay for the merchandise [38]. The order is then submitted to The Metal App [39], where user information and the shipping address are validated [40]. If valid, the usernames of both the buyer and seller are sent to the seller [41], who then ships the merchandise to the buyer's address [42]. The buyer can search the seller's [43] username and write reviews [44].

Users can browse a curated selection of items, purchase them anonymously, and send them to other users based on usernames. The Metal App acts as an intermediary, ensuring the privacy and security of both the sender and the recipient.

If the user is a seller [45], they list merchandise [46] and add preferences and location details [47]. Once the seller receives orders [48], they fulfill them [49] as part of the selling process.

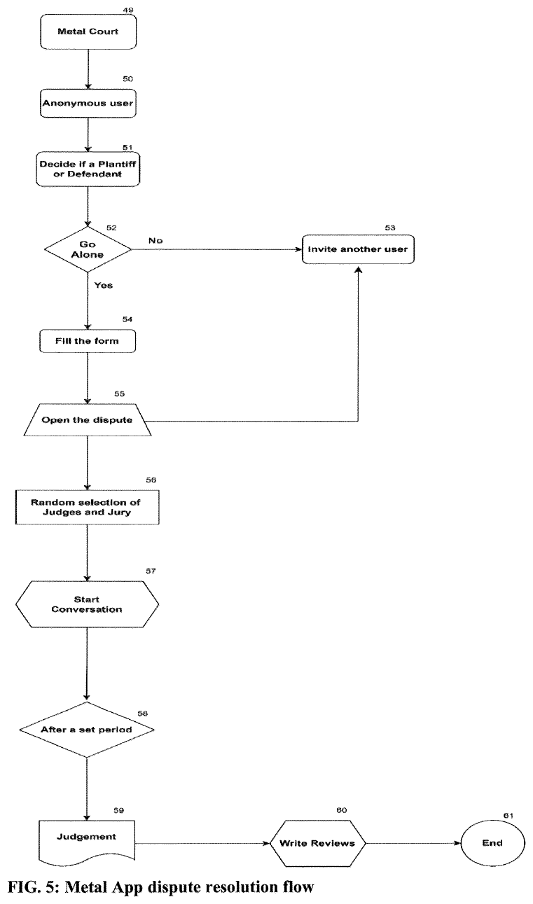

FIG. 5 Illustrates the Metal Court Dispute resolution flow.

Users can file disputes within the platform. The system provides options for mediation or a jury-based resolution. All parties involved remain anonymous throughout the process, ensuring fair and unbiased conflict resolution. The process begins by entering the Metal Court [49], where the user joins anonymously [50]. Next, the user decides whether they are a Plaintiff or Defendant [51]. If the user chooses to go alone [52], they proceed by filling out the necessary form [54] and opening the dispute [55].

Once the dispute is opened, the system randomly selects Judges and Jury [56]. After the selection, the conversation between the involved parties begins [57]. After a set period [58], a judgment is passed [59]. The parties involved and other Metal users can then write reviews [60], marking the end of the dispute resolution process [61].

The app includes a variety of interactive games designed to facilitate self-discovery and deeper connections. These games present thought-provoking questions and scenarios, encouraging users to share insights about themselves in a fun, low-pressure environment.

The Metal App's comprehensive approach addresses the limitations of existing platforms by offering a versatile solution for various relationship needs. By combining advanced technology with a strong emphasis on privacy and user experience, the invention creates a more holistic, secure, and engaging environment for building meaningful relationships.

The best mode contemplated for carrying out the invention involves deploying the mobile application on both iOS and Android platforms, with the backend server hosted on a scalable cloud infrastructure to ensure high availability and performance. The matching algorithm would be implemented using machine learning techniques to continuously improve match quality based on user feedback and interaction data.

This description outlines the key components and functionalities of the Metal App, demonstrating how it advances the state of the art in social networking and relationship-building applications.

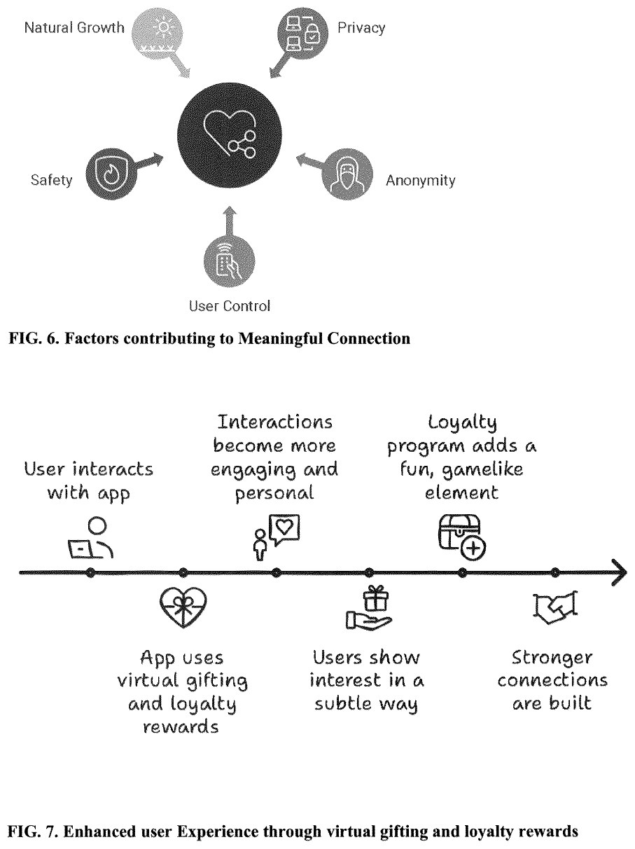

FIG. 6 Illustrates the factors contributing to Meaningful Connection, namely, Natural growth, Privacy, Safety, User control and Anonymity.

FIG. 7 demonstrates the stronger connection evolution. It illustrates how the app enhances user engagement through virtual gifting and loyalty rewards. As users interact with the app, the experience becomes more personal and fun through gamified loyalty programs, allowing users to subtly express interest. These elements help build stronger connections and improve overall user satisfaction.

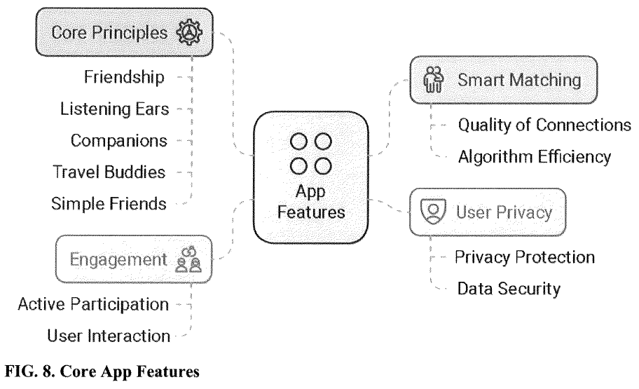

FIG. 8 outlines key features of an app, focusing on core principles like fostering friendships, companions, and travel buddies. It highlights engagement through active participation, smart matching for quality connections, and prioritizing user privacy with data security measures. These features aim to create meaningful interactions while protecting user information.

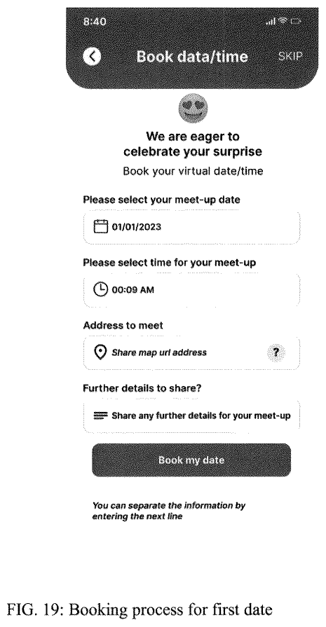

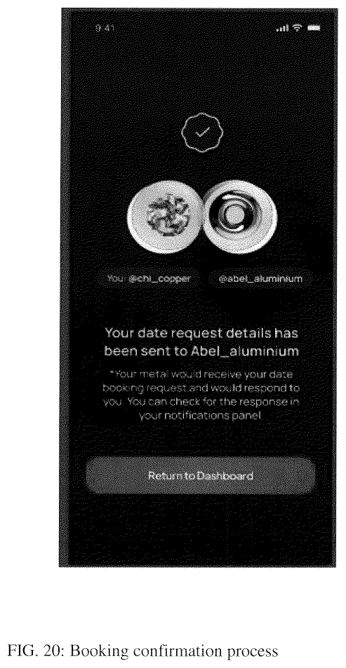

The booking system creates an intentional act for meetup after a period of blind conversations. This can be virtual via the app video calls or in a physical location FIG. 19

### DETAILED DESCRIPTION OF THE DRAWINGS

FIG. 1 provides a comprehensive overview of the Metal App system architecture, which consists of three main components: the mobile application, the backend server, and the database.

The mobile application acts as the primary interface for users, allowing them to interact with the system by accessing various features and functionalities. It is designed to be user-friendly, facilitating actions such as profile creation, messaging, and engagement with other users.

The backend server is the core processing unit of the system. It is responsible for handling all the data generated by the mobile app and executing the matching algorithm that pairs users based on specific criteria.

The server ensures smooth data flow between the app and the database, processes user requests, and executes tasks that require intensive computations, such as matching and ranking algorithms.

The database is the central repository that stores all essential data, including user profiles, preferences, interaction histories, and any other relevant information.

This data is crucial for providing personalized experiences and improving the accuracy of the matching system. Together, these three components work in harmony to deliver a seamless, efficient, and secure user experience in the Metal App system.

FIG. 2 illustrates the flow of the user interaction process. The process starts with downloading the app. New users begin by signing up, creating an account, and providing basic information. They then select a metal that represents their values and specify the type of person they are looking for.

Returning users sign in using their username and password. If any information is incomplete, they are prompted to update their profile. The system then presents a list of thoughts from potential matches, after which users can initiate anonymous conversations.

Both new and returning users complete the process and reach the final stage of interaction which can be an option to unmetal or remain a metal.

FIG. 3 outlines the flow of the anonymous matching algorithm. The process begins when a user logs into the application.

The system checks for potential matches based on the user's preferences. If no match is found, the user is presented with AI-ranked recommendations. If a match is found, the system displays ranked results in a list.

The user can then view thoughts from other users, react to those thoughts, or share their own. Users may also spend sparks to enhance their interaction. After selecting from the list, the user can send a Melt request.

If the Melt request is accepted, the user begins a conversation and can play games. If the request is not accepted, the process redirects to another attempt. The algorithm prioritizes personality traits and shared values over physical attributes, ensuring more meaningful and authentic connections by factoring in interests, life goals, and communication styles.

FIG. 4 illustrates the flow of the marketplace system. The process starts by determining whether the user is a buyer or a seller. If the user is a buyer, they select a category and location, then view items based on their search criteria. The buyer inputs their username and proceeds to pay for the merchandise.

The order is submitted to The Metal App, where user information and the shipping address are validated. If valid, the usernames of both the buyer and seller are sent to the seller, who then ships the merchandise to the buyer's address. The buyer can search for the seller's username and write reviews.

Users can browse a curated selection of items, purchase them anonymously, and send them to other users using only usernames. The Metal App acts as an intermediary, ensuring the privacy and security of both the buyer and seller.

If the user is a seller, they list merchandise, provide preferences, and add location details. Once the seller receives orders, they fulfill them as part of the selling process.

FIG. 5 illustrates the Metal Court dispute resolution process within the platform. Users can file disputes, and the system offers options for either mediation or a jury-based resolution, with all parties remaining anonymous to ensure fairness.

The process starts with users entering the Metal Court anonymously. They then choose whether they are acting as a Plaintiff or Defendant. If the user opts to proceed alone, they fill out the necessary form and open the dispute.

Once the dispute is initiated, the system randomly selects Judges and Jury. After the selection, the conversation between the involved parties begins. Following a set period, a judgment is made, and the user can write reviews, which concludes the dispute resolution process.

The app also includes interactive games aimed at promoting self-discovery and deeper connections, using fun, thought-provoking questions and scenarios. The Metal App takes a comprehensive approach to address the limitations of other platforms, providing a versatile, secure environment for building meaningful relationships.

It is designed for both iOS and Android, with a scalable cloud infrastructure for high performance, and uses machine learning techniques to continuously improve match quality based on user feedback and interactions.

This description highlights the key components and functionalities of the app, showcasing how it innovates social networking and relationship-building.

FIG. 6 Core Principles of the Metal App:—The Metal App revolves around several key principles that ensure a safe, private, and user-centric environment.
1. Natural Growth—The app fosters organic connections, allowing relationships to develop naturally over time without pressure.
2. Privacy—Protecting user data is a top priority, with strong encryption and secure data storage practices.
3. Anonymity—Users can maintain their anonymity until they feel comfortable revealing their identity.
4. Safety—The app is designed to provide a secure environment, with moderation and reporting mechanisms in place to ensure a safe user experience.
5. User Control—Users retain full control over their interactions, profiles, and personal data, making the experience highly customizable.

FIG. 7 The image outlines a process where an app enhances user experience by incorporating virtual gifting and loyalty rewards. Here's an explanation based on the image:
1. User interacts with the app: The process begins when a user engages with the app.
2. Interactions become more engaging and personal: As users continue interacting, the experience becomes more personalized and engaging.
3. App uses virtual gifting and loyalty rewards: To further enhance user engagement, the app introduces virtual gifting and loyalty reward features.
4. Users show interest in a subtle way: These features allow users to express their interest in the app or towards others within the app in a subtle manner.
5. Loyalty program adds a fun, gamelike element: The loyalty program incorporates a game-like experience, making interactions more enjoyable.
6. Stronger connections are built: As a result of these engaging features, users develop stronger connections, leading to improved user retention and satisfaction.

This process ultimately enhances the user experience by integrating interactive and rewarding elements.

FIG. 8 The image provides an overview of the core app features divided into different categories that guide the app's functionality and principles:
1. Core Principles:—Focuses on forming various types of relationships such as friendships, companions, and travel buddies. It emphasizes simple connections that enrich users' lives.
2. Engagement:—The app encourages active participation and interaction among users, aiming to foster a more engaged community.
3. Smart Matching:—Emphasizes the quality of connections made through efficient algorithms that aim to match users based on compatibility.
4. User Privacy:—Prioritizes user privacy through robust data security measures and dedicated privacy protection to ensure user information is safe and secure.

This structured approach helps in enhancing the user experience by promoting meaningful connections, active engagement, and safeguarding user data.

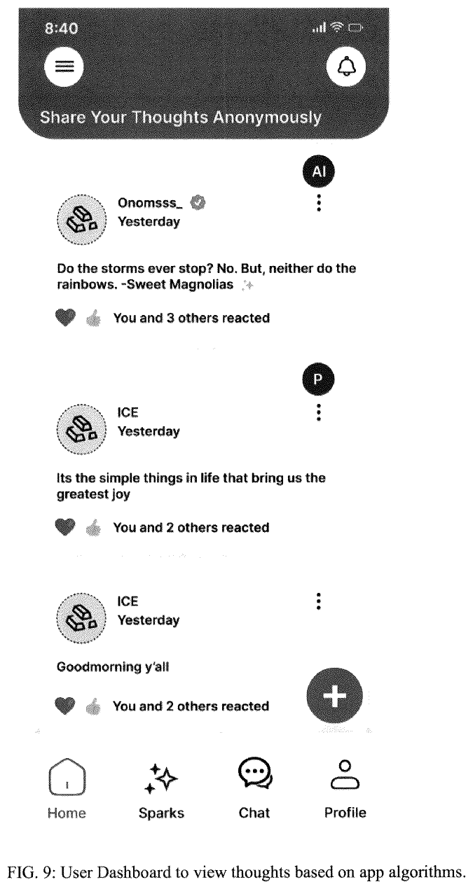

FIG. 9 The app uses thoughts posted by users to build attraction and connection between users, FIG. 9 shows that users can view a list of thoughts from other users and initiate a reaction. Metal aims at building real and deep connections and a user's thoughts can lead to some understanding of a user's interest and passion and creates initial topics for discussions. Some thoughts are highlighted with a P which means “Pushed Profile” and some with AI which means Artificial Intelligence recommended.

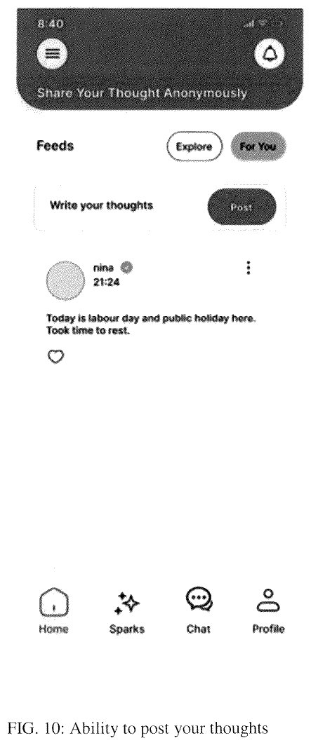

FIG. 10 shows the ability for a user to post their own thoughts so that other app users can view. The app is designed so that only those that share thoughts can be discovered by other users. To be able to match with other users, a user will need to post their thoughts so others that feel an alignment to their thought process can request for a match.

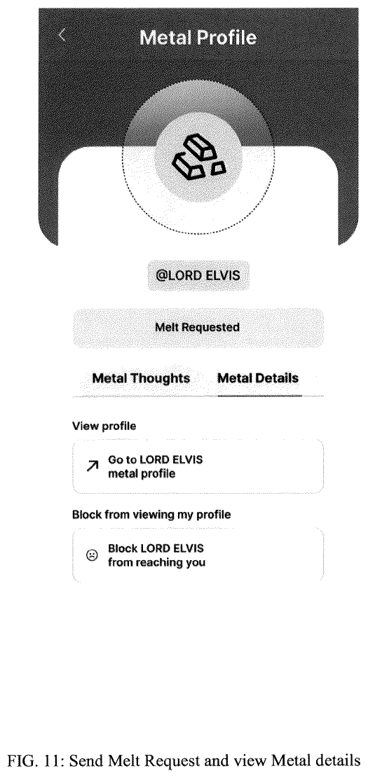

FIG. 11 users can click on a metal icon on a thought to be directed to a “Melt” page. The melt feature initiates the matching process. When a Melt request is sent, the user profile is ranked for the receiver without an indication of the request. If the receiver randomly sends a reciprocating Melt request then, the two users will have a match/melt.

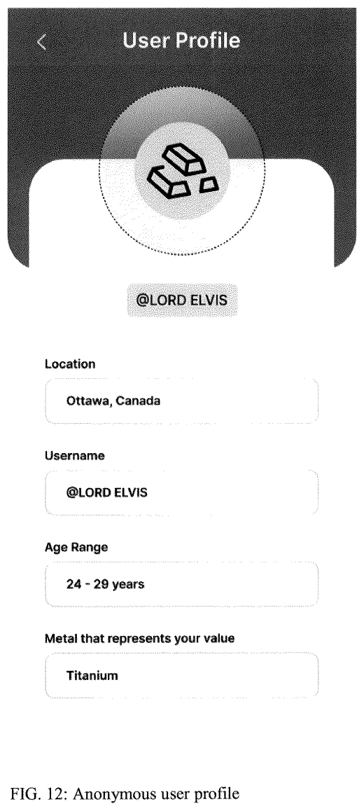

FIG. 12 displays the anonymous user profile of a Metal to any user. The profile picture by default is the symbol of the metal the user identified during the signup process. The user age is defined as a range which allows less bias when making connections. The profile includes other basic information of the user.

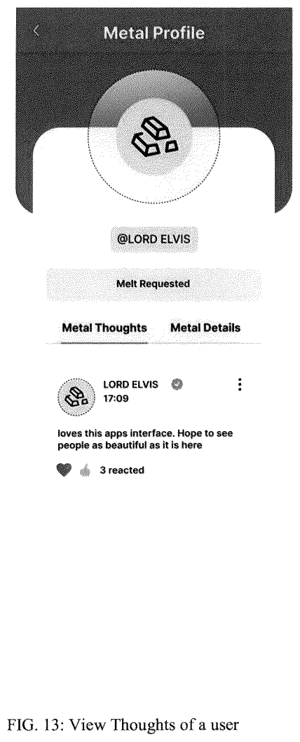

FIG. 13 the app allows users to justify the request to melt based on a review of thoughts shared by the user. This page allows users to view all the thoughts that were posted by a user over a certain period. If a user comes across a thought that generates interest, the user can decide to view a list of thoughts from the specific user to gain more insights if there are areas of alignments.

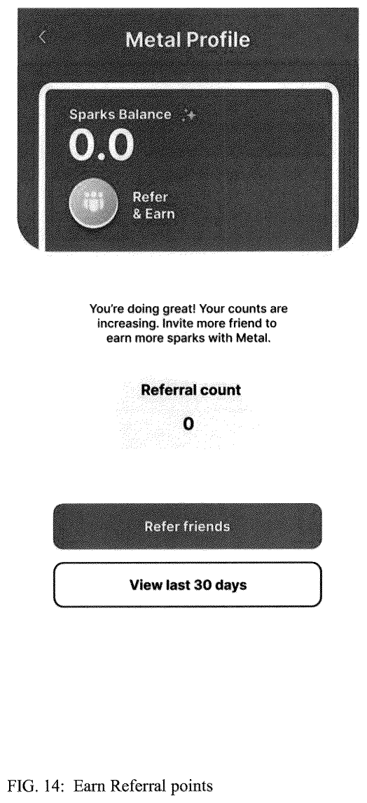

FIG. 14 users can earn Spark loyalty dollars through referrals and be able to see how many referrals they have brought in. The referral count allows users to measure their referrals against the spark dollars received through Refer & Earn for a period.

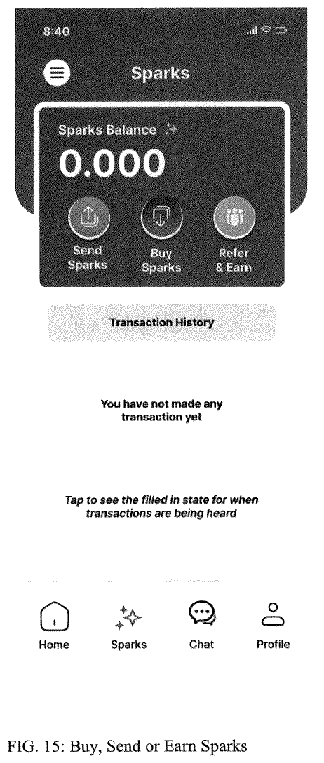

FIG. 15 users can buy spark using payment methods such as credit and debit cards or through third party systems like stripe. Users can send sparks to other users as a way of showing admiration. Users can earn spark through referral features. Spark is a monetary loyalty currency used for in-app purchases.

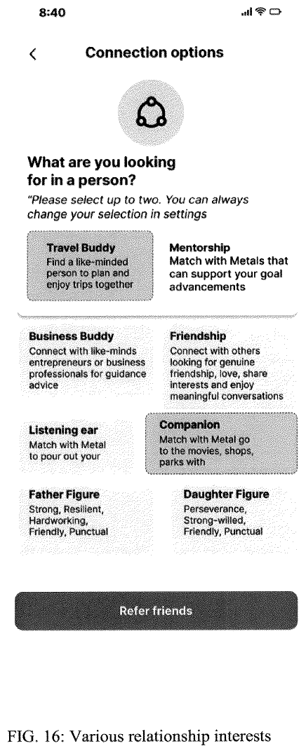

FIG. 16 users can choose the kind of relationship they are looking for such as friendship, mentorship, travel buddy and more. Users are allowed to choose one or more depending on the different relationship desires wanted. The type of relationship a user is interested in forming is displayed on the user profile.

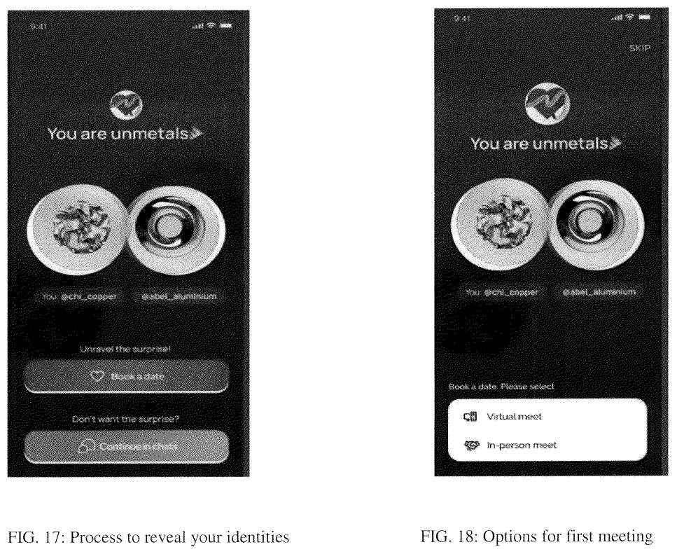

FIG. 17 users are able to become unmetals after a period of being metals and communicating anonymously. The unmetal process allows users to reveal their identities such as their real names, age and pictures. This happens only if the two parties agree to unmetal. The app allows users to remain metals as long as they desire. If two users want to unmetal, they will go through the unmetal process which requires booking a date for their first meeting or skipping the surprise.

FIG. 18 with the unmetal process, users can choose to meet virtual using an in-app video call feature or book to meet in-person. The in-person requires filling a form that includes a map link for location and a description that can allow the other users identify you since it is a blind date.

FIG. 19 this is a booking form that the user initiating the first date will complete to request a date from the other party. The form includes suggested date, time, the location of the venue and any other details that the user wants to share. The location only accepts a link to ensure safety.

FIG. 20 this is a display that shows that the other party is required to ask the date for it to happen. A confirmation notification is sent to the other party with the options to accept, reschedule or reject.

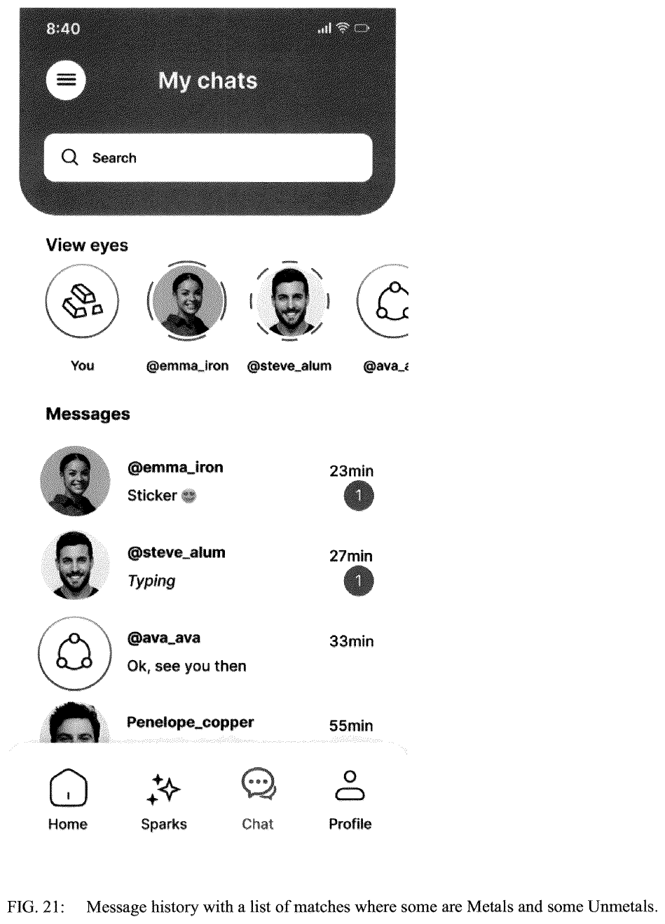

FIG. 21 this is a user's message interface that shows that some matches can be metals and some can be unmetals. The metals which are anonymous profiles have their respective metal icons as their profile pictures while the unmetals have the real pictures which only the two parties that are unmetals can see. A profile can be unmetals to some specific users and metals to others.

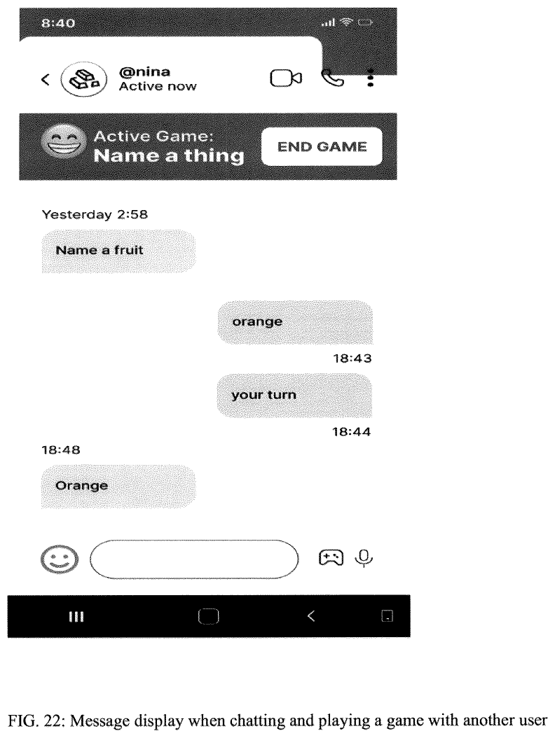

FIG. 22 when chatting with an unmetal, the real picture of the user is displayed rather than the default metal symbol.

1. A method for facilitating private connections in a mobile application, comprising: initiating and building one-on-one connections through a process of ‘melting’ or bonding, using virtual representations of metals, gems, or similar objects.

2. The method of claim 1, further comprising maintaining anonymity in conversations by enabling users to engage in anonymous conversations for a set period, with an option to ‘unmetal’ or disclose real identities after the set period or remain anonymous.

3. An anonymous dispute resolution mechanism in a mobile application, comprising: a court feature allowing users to file disputes within the platform; an option to invite another party to a resolution process or proceed alone before a ‘jury’.

4. A method for anonymous commerce in a mobile application, comprising: providing a secure marketplace for users to buy merchandise; enabling anonymous sending of purchased items to other users based on usernames; utilizing the application platform as a conveyor for transactions.

5. The method of claim 4, further comprising the ability for users to send monetary gifts as loyalty points called Sparks, which can be sent anonymously, used for subscription payments, transferred to other users, or redeemed for merchandise, with Sparks being purchased directly via a payment system or earned through referral incentives.

6. A booking system for requesting a first date or meeting, wherein the user requests a date, the other party can accept or reschedule, and the system provides notifications, virtual or physical meeting options, and map-based location input to ensure security and enhance the dating experience.

7. A dating review and rating feature for the mobile application, wherein users rate their dates on a scale range, with the scores contributing to an overall user rating displayed on profiles, and wherein users can submit reviews after meetings to the Metal app.

8. The method of claim 1, further comprising an artificial intelligence recommendation algorithm that suggests user profiles to other users for connections for dating, mentorship, or companionship based on commonalities and themes on thoughts shared, values, passion and prior connections giving users option to match with a user themselves or option for the AI recommendation.
